(19) United States
(12) Patent Application Publication
(10) Pub. No.: US 2014/0156211 A1
(43) Pub. Date: Jun. 5, 2014

(54) Tilted Test Loop Calibration System

(71) Applicant: SCHLUMBERGER TECHNOLOGY CORPORATION, Sugar Land, TX (US)

(72) Inventor: Dursun Sedat Kilic, Missouri City, TX (US)

(73) Assignee: SCHLUMBERGER TECHNOLOGY CORPORATION, Sugar Land, TX (US)

(21) Appl. No.: 13/691,012

(22) Filed: Nov. 30, 2012

(51) Int. Cl. G01C 25/00

(52) U.S. Cl. CPC G01C 25/00
USPC 702/104

(57) ABSTRACT

A tilted test loop for use in calibrating an electromagnetic logging tool includes a substantially cylindrical hub, a planar elliptical frame connected to the hub and oriented at a tilt angle with respect to a longitudinal axis of the hub, at least one triangular wedge connected to the hub and the planar frame, the triangular wedge having an angle that defines the tilt angle, and a plurality of elliptical conductive loops deployed in corresponding elliptical grooves in the frame.

### CROSS REFERENCE TO RELATED APPLICATIONS

None.

### FIELD OF THE INVENTION

Disclosed embodiments relate generally to a tilted test loop system for testing and calibrating electromagnetic logging tools configured for subsurface measurements.

### BACKGROUND INFORMATION

The use of electrical measurements in prior art downhole applications, such as logging while drilling (LWD) and wireline logging applications is well known. Such techniques may be utilized to determine a subterranean formation resistivity, which, along with formation porosity measurements, is often used to indicate the presence of hydrocarbons in the formation. Moreover, azimuthally sensitive directional resistivity measurements are commonly employed e.g., in pay-zone steering applications, to provide information upon which steering decisions may be made. Directional resistivity tools often make use of tilted or transverse antennas (antennas that have a magnetic dipole that is tilted or transverse with respect to the tool axis).

Tool calibration is an important and necessary task in directional resistivity logging operations. Factors such as imperfections in tool construction and variations due to the tool's electronics (e.g., op-amp phase accumulations) can introduce significant measurement errors. The intent of tool calibration is to eliminate and/or compensate for the effects of these factors on the measurement data. Various tool compensation methods are known. For example, the use of shielded receiving and transmitting devices is disclosed in U.S. Pat. No. 4,876,511. Conductive test loops may also be employed, for example, as disclosed in U.S. Pat. No. 5,293,128. A tilted conductive test loop is disclosed in U.S. Pat. No. 7,414,391.

Notwithstanding the use of the above methodologies, there remains a need in the art for an improved system for calibrating directional resistivity logging tools.

### SUMMARY

A tilted test loop calibration system is disclosed. In one embodiment the disclosed tilted test loop includes a cylindrical hub having a through bore sized and shaped for deployment about an electromagnetic logging tool. A planar elliptical frame is connected to the hub and oriented at a tilt angle with respect to a longitudinal axis of the hub. At least one triangular wedge is connected to the hub and the planar frame with the wedge being sized and shaped so as to define the tilt angle between the frame and the hub axis. A plurality of elliptical conductive loops is deployed in corresponding elliptical grooves in the frame.

The disclosed embodiments may provide various technical advantages. For example, the disclosed embodiments may be utilized to calibrate all elements in a trans-impedance matrix that defines various couplings between transmitter and receiver antennas in an electromagnetic directional resistivity tool or a tilted magnetic dipole electromagnetic tool. The disclosed tilted test loop may be used both in master tool calibration and field calibration. In field application, the tilted test loop provides a convenient means of checking an electromagnetic logging tool before and/or after a logging operation to ensure that the log data are reliable.

The disclosed tilted test loop embodiments make use of one or more triangular wedges to define a tilt angle between the planar conductive loops and the electromagnetic logging tool with a high degree of accuracy (e.g., within ±0.1 degree). The disclosed embodiments thereby provide for highly accurate calibration and/or data correction. Moreover, the configuration including multiple conductive loops provides a versatile arrangement that may be used to calibrate a wide range of transmitter and receiver antenna combinations thereby simplifying the calibration procedure for electromagnetic logging tools having a large number of transmitter and receiver antennae.

This summary is provided to introduce a selection of concepts that are further described below in the detailed description. This summary is not intended to identify key or essential features of the claimed subject matter, nor is it intended to be used as an aid in limiting the scope of the claimed subject matter.

### DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts one example of a tilted test loop deployed on an electromagnetic logging tool.

FIG. 2 depicts a perspective view of the tilted test loop shown on FIG. 1.

FIG. 3 depicts a side view of the tilted test loop shown on FIG. 1.

FIG. 4 depicts a cross sectional view of the tilted test loop shown on FIG. 3.

FIG. 5 depicts another cross sectional view of a portion of the tilted test loop shown on FIG. 3.

FIG. 6 depicts a flow chart of one disclosed method embodiment.

### DETAILED DESCRIPTION

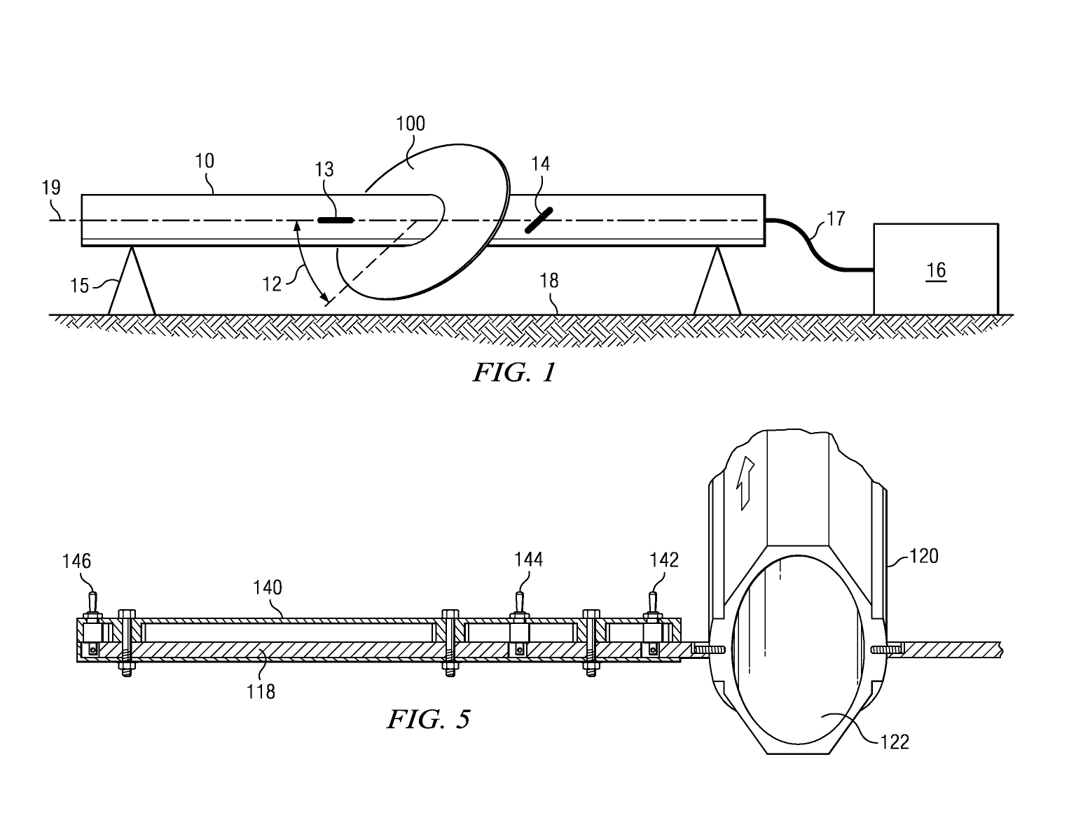

FIG. 1 depicts a one example of a disclosed tilted test loop 100 deployed about an electromagnetic logging tool 10. The logging tool 10 may include a wireline tool, a logging while drilling (LWD) tool, a measurement while drilling (MWD) tool, or substantially any other suitable downhole electromagnetic measurement tool. Such tool may include, for example, directional resistivity tool including transverse transmitter and/or receiver antennae and/or tilted antennae. The depicted tool embodiment 10 includes a transmitter antenna 13 and a receiver antenna 14. A cable 17 connects the electromagnetic logging tool 10 with a computer (including a processor) 16, thereby allowing for recording and/or processing of the collected data.

In the depicted configuration, the tilted test loop 100 lies in a plane (not shown) that intercepts the tool 10 at a tilt angle 12. Due to this arrangement, the magnetic dipole of the tilted test loop 100 is not coincident with the tool axis 19. The tilt angle 12 may be selected to provide optimal coupling between the tilted test loop 100, the transmitter antenna 13, and the receiver antenna 14. Those of ordinary skill in the art will readily appreciate that an optimal tilt angle is dependent on the transmitter antenna 13 and the receiver antenna 14 configurations (e.g., tilted, axial, or transverse). In an electromagnetic tool embodiment having mutually orthogonal transverse antennas, an optimal tilt angle is about 45 degrees. For electromagnetic tool embodiments having tilted antennas, the optimal tilt angles may be larger or smaller than 45 degrees. Disclosed embodiments may make use of a tilt angle from about 0 to 90 degrees.

The size and shape of the tilted test loop 100 is variable and may be selected to optimize the coupling between the transmitter antenna 13 and the receiver antenna 14. The size of the tilted test loop 100 may be commensurate with the axial separation between the transmitter antenna 13 and the receiver antenna 14. With a larger axial separation between the antennas, it may be advantageous to make use of a tilted test loop having a larger diameter, while with a smaller axial separation; a smaller diameter tilted test loop may be more suitable.

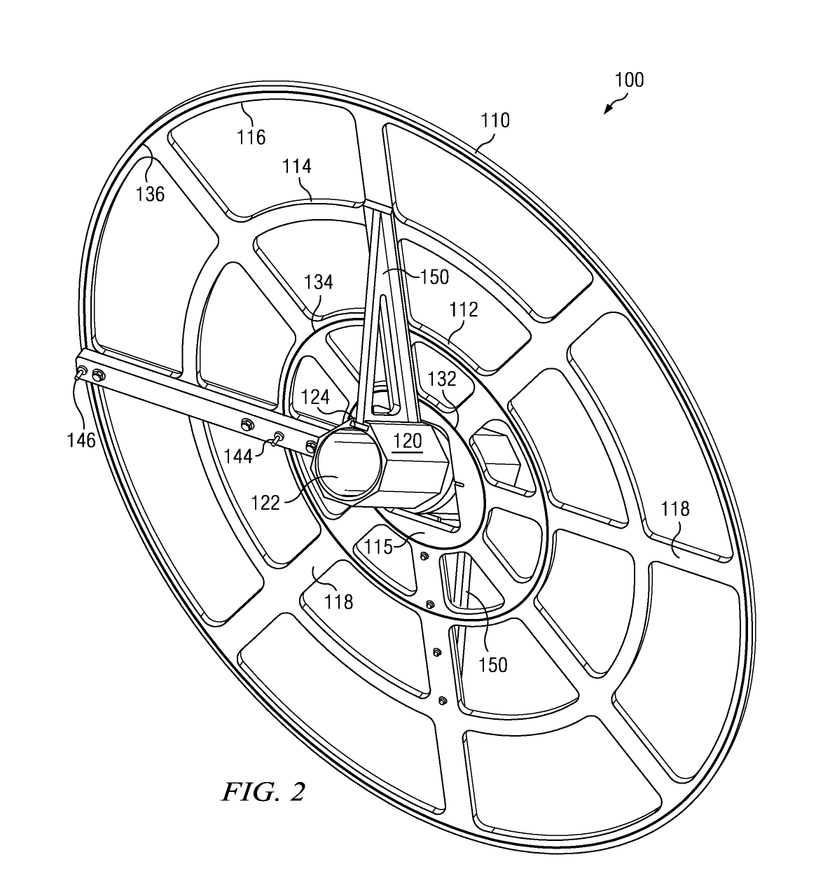

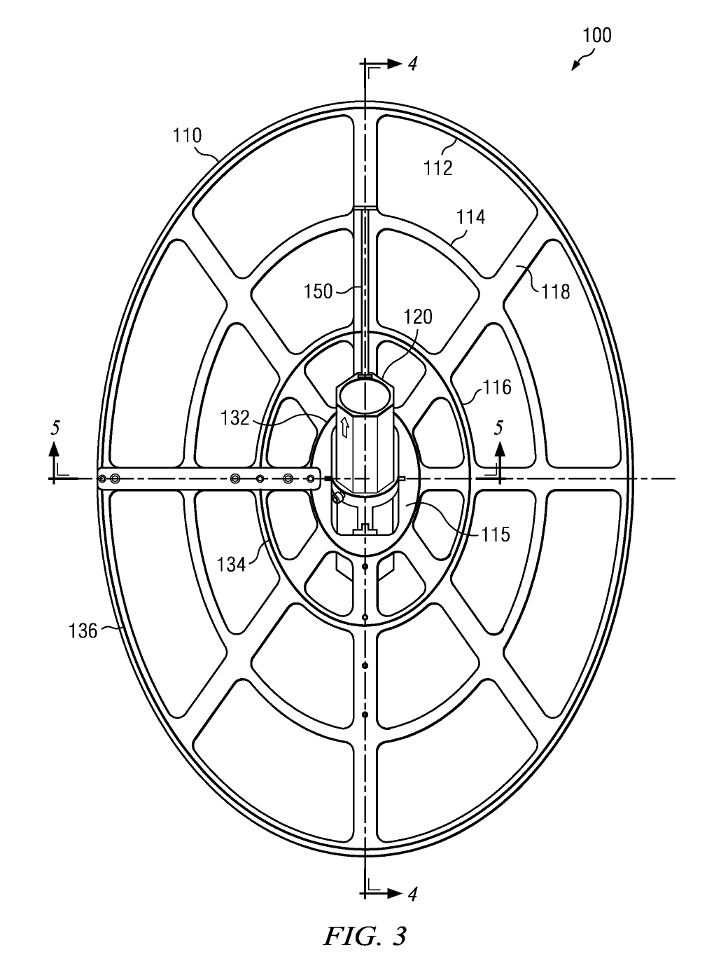

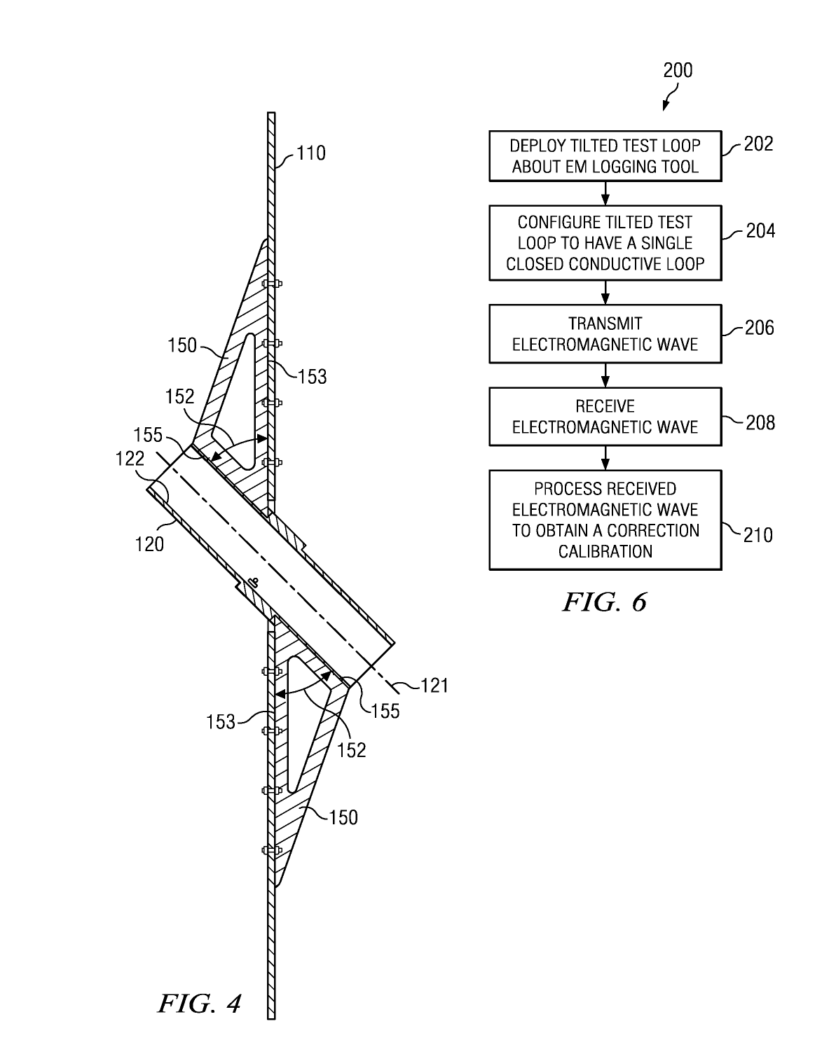

FIGS. 2-5 depict one example of a disclosed tilted test loop 100. The disclosed embodiment includes an elliptical frame (or plate) 110 deployed on a substantially cylindrical hub 120. In the depicted embodiment the frame is tilted at an angle 152 of 45 degrees with respect to the longitudinal axis 121 of the hub 120. Frame 110 includes a plurality of elliptical rings 112, 114, and 116 supported by a plurality of radial supports 118. The radial supports 118 extend radially outward from a central disk 115 which is deployed about the hub 120. The structure of the frame 110 is intended to provide a rigid (substantially non bendable), planar framework for conductive loops 132, 134, and 136 deployed therein. The frame 110 and hub 120 may be advantageously fabricated from a mechanically rigid, electrically non-conductive material such as a polyvinyl chloride (PVC). The disclosed embodiments are of course not limited to any particular material of construction.

Hub 120 includes a through bore 122 having an inner diameter sized and shaped to fit securely about the outer diameter (outer surface) of an electromagnetic logging tool such that the hub 120 and the logging tool are substantially coaxial upon deployment of the hub about the logging tool. Although not shown on the FIGS., the hub may further include a pin, a threaded knob, or other similar fastening or gripping device configured to secure the hub to the logging tool body to prevent relative axial and rotational motion. During a calibration procedure the tilted test loop 100 may be positioned in a desired position on the logging tool body and the threaded knob tightened to secure the test loop 100 in place. The through bore 122 may have an inner diameter large enough to permit sliding of the test loop 100 along the length of a logging tool, but small enough so that the fit about the outer diameter of the logging tool is somewhat snug (i.e., not so loose or sloppy as to preclude accurate and reliable positioning but not so tight as to restrict sliding). For example only, hub 120 may include a though bore 122 having an inner diameter of about 4.5 inches for deployment about a conventional six-inch electromagnetic logging while tool (a logging while drilling tool configured for deployment in a borehole having a diameter of six inches). The disclosed embodiments are of course not limited to any particular hub dimensions.

Tilted test loop 100 further includes first and second wedges 150 that connect the frame 110 to the hub 120. The wedges are sized and shaped to provide for a highly accurate and controllable angle between the frame 110 and the longitudinal axis 121 of the hub 120 (and therefore between the frame 110 and the longitudinal axis of an electromagnetic logging tool about which the test loop 100 is deployed). In the depicted embodiment, each of the wedges 150 is triangular in shape and includes a hypotenuse 153 that is connected (e.g., screwed or bolted) to one of the radial supports 118 on the frame 110 and a leg 155 that engages a dovetail groove 124 in the hub 120. The angle 152 between the hypotenuse 153 and the leg 155 defines the angle between the frame 110 and the longitudinal axis 121 of the hub 120. The use of the aforementioned triangular wedge and dovetail groove configuration advantageously enables the angle between the plate 110 and the longitudinal axis 121 to be controlled with high tolerance. For example, in the depicted embodiment, angle 152 is equal to 45.0±0.1 degrees. Such high tolerance further enables highly accurate calibration of the electromagnetic logging tool.

The embodiment depicted on FIGS. 2-5 includes first, second, and third inner, middle, and outer conductive loops 132, 134, and 136 deployed in the frame 110. The first inner conducive loop 132 is deployed in an elliptical groove in the central disk 115. The second middle conductive loop 134 is deployed in an elliptical groove in elliptical ring 112. The third outer conductive loop is deployed in a groove in elliptical ring 116. The conductive loops may be fabricated, for example, from conventional electrically conductive copper or copper alloy wire. The grooves may have a depth of half the thickness of the frame such that each of the loops 132, 134, and 136 is substantially coplanar with the other loops. It will be understood that the disclosed embodiments are not limited to embodiments having any particular number of conductive loops. While the depicted embodiment 100 includes first, second, and third conductive loops 132, 134, and 136, it will be understood that the disclosed tilted test loop may include more or less conductive loops. For example, the depicted embodiment 100 may optionally include a fourth conductive loop (not shown) deployed in a corresponding groove in elliptical ring 114.

Tilted test loop 100 may be sized and shaped such that the conductive loops have substantially any suitable diameter and eccentricity. In embodiments in which the angle between the frame 110 and the hub axis 121 is about 45 degrees, the eccentricity of the elliptical conductive loops may be about 0.7 (i.e., about \sqrt{2}/2). For example, in the depicted embodiment, the inner loop 132 has a minor diameter of 10 inches and a major diameter of 14.1 inches (10\sqrt{2} inches). The middle loop 134 has a minor diameter of 19 inches and a major diameter of 26.9 inches (19·\sqrt{2}). And the outer loop 136 has a minor diameter of 48 inches and a major diameter of 67.9 inchers (48·\sqrt{2}). It will be understood that the disclosure is not limited to any particular conductive loop size or eccentricity.

With particular reference to FIG. 5, the conductive loops may be configured to be electrically opened and closed. For example, as depicted, switches 142, 144, and 146 are deployed in corresponding conductive loops 132, 134, and 136. The switches may be physically supported, for example, by a switch housing 140 deployed on one of the radial supports 118. Opening an individual switch opens the corresponding circuit such that the conductive loop is incomplete (i.e., the conductive pathway is interrupted such that there is no conductive pathway about the entirety of the loop). Closing an individual switch closes the corresponding circuit such that the conductive loop is complete (i.e., there is a conductive pathway about the entirety of the loop). The switches may be opened and closed in any combination, however, during a calibration procedure; one switch may be closed while the others are opened. For example only, switches 142 and 146 may be open and switch 144 closed such that only conductive loop 134 is complete and there is no conductive pathway about loops 132 and 136. It will be understood that the disclosed embodiments are not limited to switches, but may also include breakers, manual jumpers, or other known means for making and breaking connection between ends of the conductive loops.

After manufacture, an electromagnetic logging tool may be initially calibrated in a procedure referred to as a master tool calibration. The master tool calibration may be performed at the point of manufacture or in a laboratory. Upon passing the initial (master) calibration, the tool may be delivered to the job site, where additional testing or calibration may be performed before and/or after a logging operation to ensure that the logging data are reliable. This additional testing/calibration is referred to as field calibration. The tilted test loop depicted on FIGS. 2-5 may be used for both master tool calibration and field calibration procedures.

With reference again to FIG. 1, electromagnetic logging tool 10 is equipped with a tilted receiver antenna 14 and a transverse transmitter antenna 13. This particular configuration is for illustration only. The disclosed embodiments are not limited to any particular transmitter-receiver configuration. The logging tool 10 may be suspended above the ground 18 during calibration, e.g., substantially horizontally on tool stands 15. The tool may also be suspended vertically from a crane (not shown), or in any other suitable setup. The particular setup for calibrating the logging tool 10 is immaterial.

When the transmitter 13 is energized, electromagnetic energy is emitted into the surroundings. The emitted energy induces an eddy current in the conductive loop of the tilted test loop 100. The induced eddy current in turn produces a secondary electromagnetic field in the surroundings. This secondary field induces a voltage signal in the receiver antenna 14 via a coupling between the conductive loop and the receiver antenna 14. The voltage signal may then be recorded and compared with a theoretical (calculated) voltage based on a model including the coupling effect of the conductive loop. Signals induced at the receiver antenna due to background effects are accounted for in the voltage comparison.

In a further embodiment, a second measurement may be made with the tilted test loop removed, with the conductive loop opened (e.g., via the aforementioned switch or breaker), or with an alternative conductive loop closed (e.g., a loop having a different diameter). The voltage thus detected in the receiver antenna 14 may be recorded and compared with the first measurement described in the preceding paragraph. The difference in the voltage signals is related to coupling effects of the conductive loop and may be used compute various calibration/correction parameters.

FIG. 6 depicts a flow chart of one example of a disclosed method embodiment 200. In method embodiment 200 a tilted test loop such as that depicted in FIGS. 2-5 is deployed about an electromagnetic logging tool at 202 (e.g., as shown on FIG. 1). As described above, the tilted test loop includes a frame having a plurality of conductive loops deployed thereon. At least one triangular wedge is connected to the frame and a cylindrical hub to define the angular tilt of the frame with respect to the hub (and the electromagnetic logging tool). At 204 the tilted test loop is configured such that a single one of the conductive loops is complete, for example, via closing a corresponding switch or breaker. The other loop (or loops) is/are interrupted, for example, via opening corresponding switches or breakers. At 206 the electromagnetic tool is energized such that a predetermined transmitter antenna transmits an electromagnetic wave into the surroundings. The electromagnetic wave is influenced (via electromagnetic coupling) by the closed (or complete) conductive loop. A corresponding voltage signal is then measured at a predetermined receiver at 208. The measured signal is then processed at 210 to determine a correction (or calibration) for the transmitted and/or received signal. This procedure may be repeated substantially any number of times using alternative transmitting and receiver antenna and different tilted test loop configurations (e.g., a different one of the conductive loops being closed or with each of the conductive loops opened). Moreover, the tilted test loop may be repositioned at the logging tool body as may be desirable for calibrating other transmitting and receiver antenna combinations.

The procedure by which the measured signal is processed in 210 may include computing calibration coefficients in a two- or three-dimensional tensor that couples the transmitter to the receiver. U.S. Pat. No. 7,414,391 to Homan et al, which is fully incorporated by reference herein, discloses one such procedure.

Although a tilted test loop calibration system and certain advantages thereof have been described in detail, it should be understood that various changes, substitutions and alternations can be made herein without departing from the spirit and scope of the disclosure as defined by the appended claims.

What is claimed is:

1. A tilted test loop for use in calibrating an electromagnetic logging tool, the tilted test loop comprising:
a substantially cylindrical hub having a longitudinal axis and a through bore sized and shaped for deployment about the electromagnetic logging tool;
a planar elliptical frame connected to the hub and oriented at a tilt angle with respect to the longitudinal axis of the hub;
at least one triangular wedge connected to the hub and the planar frame, the triangular wedge having an angle that defines the tilt angle; and
a plurality of elliptical conductive loops deployed in corresponding elliptical grooves in the frame.

2. The tilted test loop of claim 1, further comprising first and second substantially identical triangular wedges deployed on opposing sides of the frame.

3. The tilted test loop of claim 1, wherein the triangular wedge comprises a hypotenuse that is connected to the frame and a leg that is connected to the hub.

4. The tilted test loop of claim 3, wherein the leg engages a dovetail groove in the hub.

5. The tilted test loop of claim 3, wherein the angle that defines the tilt angle is an angle between the hypotenuse and the leg of the triangular wedge.

6. The tilted test loop of claim 1, wherein the tilt angle has an angular tolerance of less than or equal to ±0.1 degrees.

7. The tilted test loop of claim 1, wherein each of the plurality of conductive loops includes a corresponding switch configured to selectively open and close the conductive loop.

8. The tilted test loop of claim 1, wherein the frame comprises (i) a central disk, (ii) a plurality of elliptical rings, and (iii) a plurality of radial supports that connect the elliptical rings to the central disk.

9. The tilted test loop of claim 7, wherein:
a first of the plurality of conductive loops is deployed in an elliptical groove in the disk; and
a second of the plurality of conductive loops is deployed in an elliptical groove in one of the plurality of elliptical rings.

10. The tilted test loop of claim 8, wherein a third of the plurality of conductive loops is deployed in an elliptical groove in a second of the plurality of elliptical rings.

11. A system for calibrating an electromagnetic logging tool, the system comprising:
an electromagnetic logging tool having a tool body, a plurality of transmitter antennae, and a plurality of receiver antennae;
a tilted test loop deployed on the electromagnetic logging tool, the tilted test loop including (i) a substantially cylindrical hub deployed about the electromagnetic logging tool, (ii) a planar elliptical frame connected to the hub and oriented at a tilt angle with respect to a longitudinal axis of the hub, (iii) at least one triangular wedge connected to the hub and the planar frame, the triangular wedge having an angle that defines the tilt angle, and (iv) a plurality of elliptical conductive loops deployed in corresponding elliptical grooves in the frame; and
a processor including instructions to (a) cause one of the transmitter antennae to transmit an electromagnetic wave, (b) cause one of the receiver antennae to receive the transmitted electromagnetic wave, and (c) process the received electromagnetic wave to compute a calibration of the electromagnetic logging tool.

12. The system of claim 11, wherein the tilted test loop further comprises first and second substantially identical triangular wedges deployed on opposing sides of the frame.

13. The system of claim 1, wherein the triangular wedge comprises a hypotenuse that is connected to the frame and a leg that is connected to the hub via engagement with a dovetail groove.

14. The system of claim 13, wherein the angle that defines the tilt angle is an angle between the hypotenuse and the leg of the triangular wedge.

15. The system of claim 11, wherein the tilt angle has an angular tolerance of less than or equal to ±0.1 degrees.

16. The system of claim 11, wherein each of the plurality of conductive loops includes a corresponding switch configured to selectively open and close the conductive loop.

17. The system of claim 11, wherein:
the frame comprises (i) a central disk, (ii) a plurality of elliptical rings, and (iii) a plurality of radial supports that connect the elliptical rings to the central disk.
a first of the plurality of conductive loops is deployed in an elliptical groove in the disk;
a second of the plurality of conductive loops is deployed in an elliptical groove in one of the plurality of elliptical rings; and
a third of the plurality of conductive loops is deployed in an elliptical groove in a second of the plurality of elliptical rings.

18. A method for calibrating an electromagnetic logging tool, the method comprising:
(a) deploying a tilted test loop about the electromagnetic logging tool, the tilted test loop including (i) a substantially cylindrical hub deployed about the electromagnetic logging tool, (ii) a planar elliptical frame connected to the hub and oriented at a tilt angle with respect to a longitudinal axis of the hub, (iii) at least one triangular wedge connected to the hub and the planar frame, the triangular wedge having an angle that defines the tilt angle, and (iv) a plurality of elliptical conductive loops deployed in corresponding elliptical grooves in the frame;
(b) configuring the tilted test loop such that a single one of the plurality of conductive loops is closed and all others of the plurality of conductive loops are open;
(c) causing a transmitter antenna on the electromagnetic logging tool to transmit an electromagnetic wave;
(d) causing a receiver antenna on the electromagnetic logging tool to receive the electromagnetic wave transmitted in (c); and
(e) causing a processor to compute a calibration for the electromagnetic logging tool from the electromagnetic wave received in (d).

19. The method of claim 18, further comprising:
(f) repositioning the tilted test loop on the electromagnetic logging tool; and
(g) repeating (b), (c), (d), and (e) to compute another calibration for the electromagnetic logging tool.

20. The method of claim 18, further comprising:
(f) reconfiguring the tilted test loop such that another single one of the plurality of conductive loops is closed and all others of the plurality of conductive loops are open; and
(g) repeating (c), (d), and (e) to compute another calibration for the electromagnetic logging tool.
